(19) United States
(12) Patent Application Publication
(10) Pub. No.: US 2013/0027555 A1
(43) Pub. Date: Jan. 31, 2013

(54) Method and Apparatus for Processing Aerial Imagery with Camera Location and Orientation for Simulating Smooth Video Flyby

(71) Applicant: William D. Meadow, Jacksonville, FL (US)

(72) Inventor: William D. Meadow, Jacksonville, FL (US)

(21) Appl. No.: 13/470,303

(22) Filed: May 12, 2012

Related U.S. Application Data
(60) Provisional application No. 61/513,654, filed on Jul. 31, 2011.
(60) Provisional application No. 61/513,660, filed on Jul. 31, 2011.

(51) Int. Cl. H04N 7/18

(52) U.S. Cl. 348/144; 348/E07.085

(57) ABSTRACT

The present invention relates to methods and apparatus to generate visualizations of aerial imagery capable of simulating movement as if the image capturing device had captured image frames at a much higher rate than the rate captured. More specifically, the visualizations of the aerial imagery which can include orthogonal approaching and departing view perspectives to generate simulated smooth flyby videos.

### CROSS REFERENCE TO RELATED APPLICATIONS

The present application claims priority to United States Pending Patent Application SKY.0002PSP, application Ser. No. 61/513,654 filed Jul. 31, 2011 and entitled “Apparatus and Methods for Capture of Image Data from an Aircraft” and also SKY.0003PSP, application Ser. No. 61/513,660, filed Jul. 31, 2011 entitled, “Methods and Apparatus for Aerial Image Alignment”, and also CC.0004NP, application Ser. No. 13/467,974, filed May 9, 2012, and entitled “Method and Apparatus for Automated Camera Location and Orientation with Image Processing and Alignment to Ground Based Reference Point(s)”, the contents of which are relied upon and incorporated by reference.

### FIELD OF THE INVENTION

The present invention relates to methods and apparatus for the processing of Aerial Imagery with precise location and orientation of one or more image capturing devices to enable viewing of a smooth Video Fly-by from a variety of viewing angles.

### BACKGROUND OF THE INVENTION

Images of specific parcels of land, structures or landmarks can be identified with satellite or ground based camera platforms. Although functional for some applications, satellite images are generally limited to the direct overhead or orthogonal views of a parcel of land or landmark and do not provide different angular overhead, perspective, or oblique views in a consistent and orderly formats that can allow visualizations of imagery to simulate movement.

The capturing of high resolution aerial images for processing requires cameras that have precise orientations. Obtaining precise orientation of cameras mounted on the aircraft is currently a challenge due to aircrafts being subject to turbulence. The industry has used various methods and apparatus to solve for the challenges that turbulence presents. Some of these methods and apparatus include the use of gyroscopes to maintain straight down camera positions.

Another known method used historically includes designating landmarks such as large white X patterns painted on roads to enable a post process manual registration and alignment of aerial image tiles, and/or to reference existing structures with known bench marks.

Also image capturing systems are sometimes gimbled and/or gyroscopically stabilized to generate images in real time and which are acceptable for some image processing applications. Although useful for some applications, all of these known techniques provide for methods and apparatus that can be impractical, high costs, and more importantly, do not support a plurality of cameras positioned in oblique or angular overhead views from an aerial platform. As a result, additional apparatus and methods are desired to enable low cost highly automated registration of aerial images.

Using the methods that include the previously mentioned and/or described herein, it is desired to enable new and practical ways to process the captured aerial imagery to enable video from a variety of viewing angles, the subject matter of the present invention.

### SUMMARY DESCRIPTION OF THE INVENTION

Accordingly, the present invention provides methods and apparatus to generate visualizations of aerial imagery capable of simulating movement at various rates as if the image capturing device had captured image frames at a much higher rate than the rate captured. More specifically, the visualizations of the aerial imagery which can include orthogonal approaching and departing view perspectives.

In some aspects of the present invention, pixels from a still photograph can be mathematically morphed to blend two images together to thereby simulate a number of captured image frames in between the two images. In some embodiments, mathematically morphing of the images can significantly decrease the number of captured frames that would be required to simulate movement and consequently lower memory space requirements and faster processing can result.

In other aspects of the present invention, the pixels may be morphed in more than one direction to allow for the desired perspectives. Additionally, layers of overlayed metadata may also be morphed simultaneously to provide a different angle perspective for both the captured image and the overlayed layer. Dimensional imagery from the different angle perspectives may also be arranged in a Melded Image Continuum.

In yet additional aspects of the present invention, the resolution of the images can vary depending on a number of factors, such as, the simulated movement speed. However, it may be desired that the captured aerial images' resolution vary within an approaching/departing simulation at a constant simulated movement speed. For example, it may be desired to start and end the simulation with high resolution images and to use lower resolution images. In some embodiments, this can increase the speed of processing and present to the viewer a simulation that appears to be in high definition. Also, one or more Synthesized Interstitial Image(s) may be generated at any one specific point in time during the aircraft's traveled path. The Synthesized Interstitial Image(s) may then be implemented in a number of systems with different functionality. For example, the Synthesized Interstitial Image(s) may be used to generate two-dimensional or three dimensional maps or models.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates an exemplary camera apparatus assembly according to some embodiments of the present invention.

FIG. 2 illustrates an exemplary configuration of multiple scopes of image capture 201-214 associated with an array of image capture devices.

FIG. 3 illustrates an exemplary diagram with Target Features for Alignment identified in one or more frames of image data captured in a scope of image data by an image capture device.

FIG. 4 illustrates a close up of a pictorial exemplary representation of a subject geographic area.

FIG. 5A illustrates a controller that may be utilized to implement some embodiments of the present invention.

FIG. 5B illustrates exemplary method steps that may be implemented in some aspects of the present invention.

FIG. 5C illustrates an exemplary representation of how the alignment can be accomplished by varying the roll, pitch and yaw of an aircraft.

FIG. 6 illustrates exemplary field of view angles of an artifact from image capturing devices mounted on an aerial vehicle.

FIG. 7 illustrates exemplary angles of capture to help explain processing techniques that can facilitate the processing of some angular perspectives.

FIG. 8A illustrates an exemplary Point of Reference Offset given by a global positioning system.

FIG. 8B illustrates patterns that may be used by exemplary alignment software of the present invention.

FIG. 9 is still another exemplary representation of how mathematical algorithms may be used to align existing property data with aerial image data.

FIG. 10 illustrates exemplary pixel morphed frames to enable the simulation of different image capturing at different distances.

FIG. 11 illustrates an oblique field of view perspective with simulated frame representations to help explain processing steps of a smooth video flyby simulation.

FIG. 12 illustrates a continuum of an aerial oblique simulated frames to help explain how image processing software can simulate smooth video flyby.

FIG. 13 illustrates an exemplary change in image capturing devices when the aircraft flies over a target point to obtain views from different angular perspectives.

FIG. 14 illustrates an exemplary screen shot of exemplary smooth video flyby software which may be used for the present invention.

### DETAILED DESCRIPTION

The present invention provides for the use of two or more Aerial images for the processing of image data generate visualizations of aerial imagery capable of simulating movement. More specifically, the visualizations of the aerial imagery which can include oblique and/or orthogonal approaching and departing view perspectives for a variety of commercial, consumer and government applications.

In the following sections, detailed descriptions of embodiments and methods of the invention will be given. The description of both preferred and alternative embodiments though through are exemplary only, and it is understood that to those skilled in the art that variations, modifications and alterations may be apparent. It is therefore to be understood that the exemplary embodiments do not limit the broadness of the aspects of the underlying invention as defined by the claims.

### GLOSSARY

“Aerial Images with Location Data” as used herein refers to data delineated or systematically arranged with one or more of: constituent time elements, geometric elements of a plane in latitude (x), longitude (y), and altitude (z) space, heading of the aircraft, and orientation of the image capturing device roll (r), pitch (p), and yaw (y). For example, it can include data sets associated with a Cartesian Coordinate designating a geographic location in at least two dimensions, such as for example, latitude, longitude and supplemented with altitude. Further, it may additionally include data sets associated with the heading and orientation of the image capturing device to roll, pitch and yaw of an aircraft.

“Aircraft” as used herein refers to an aerial vehicle that can be subjected to atmospheric fluctuations, such as turbulence resulting from wind gusts. An aircraft can include, for example an airplane, drone, helicopter, a flotation device (such as a balloon); a glider, or any other airborne vehicle operating within an atmospheric layer.

“Analysis Domain” as used herein refers to predetermined programmed thresholds in spatial location that can enable the system to limit the location of at least one target feature for image alignment, for the image alignment of the captured image with another. Consequently, in some embodiments, the image capture device's domain can limit the number of calculations the program must perform to calculate a more accurate location and orientation of an aerial imaging platform and/or the field of view of an image capturing device.

“Automated Registration” as used herein refers to the registration of image pixel data in a processor that can be matched by the processor with one or more available modes of target feature alignment, such as edge detection or color patterns of structures. For example, an image with coded data pertaining to the location of the Analysis Domain image capture sensor during capture (e.g. latitude, longitude and altitude) and/or the angle of orientation in reference to a plane and to roll, pitch and yaw.

“Deturbulizer” as used herein refers to the processing of data to process and display imagery captured from an aircraft, as if it was not subject to windgusts (i.e. turbulence). For example, data may be melded with available map data layer(s) to mathematically align it with the captured imagery to thereby find a best fit and obtain highly accurate geo-spatial measurements.

“Flatten” and also referred to as “Flattening an Image”, as used herein, refers to a change in the perspective distortion of an image captured from an oblique viewpoint. For example, pixel by pixel manipulation of the image to introduce significant changes to structures of the image to allow for quicker processing of the image.

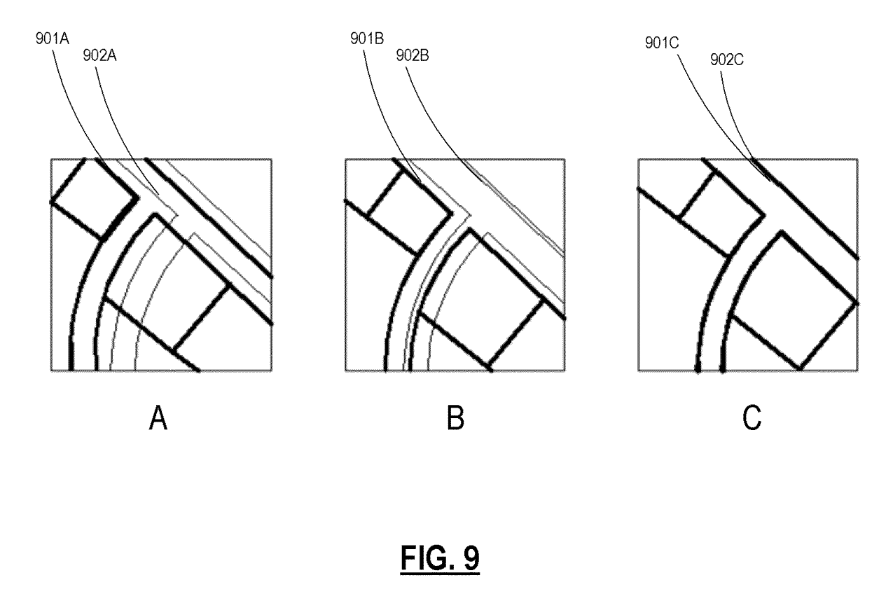

“Matching Algorithm” as used here refers matching pattern algorithms in software that is capable of taking a set of pixels within an image frame running a variety of iterative processes. For example, an alignment algorithm may be performed by varying the orientation of a image capturing device in relation to a roll, pitch and yaw of an aircraft, for a set of two or more images captured one second apart until the variance between the expected pattern such as a road center line in the geospatial data matched the high contrast edges found in the image is minimal (as illustrated in FIG. 9) to obtain a precise location and orientation of the image capturing device at a time of image capture.

“Melded Image Continuum” as used herein refers to melded discrete image data captured frames from disparate points along a first continuum to form composite imagery from the alignment of two or more of the image data sets. Unlike stitching processes, the alignment of portions of data can be from more than one data set through image data processing. In some embodiments, the composite image can be essentially two dimensional or three dimensional image data arranged as a second and/or third continuum, or ribbon. The second and/or third continuum may include ongoing image data captured from the points defining the first, second or third continuum. In some embodiments, the melded images can include overlays of superimposed data, for example, property lines, county lines, etc.

“Open Street Existing Map Data” and sometimes referred to as “Available Map Data” refers to publicly available map data that comprises geospatial data that can be used in the processing of the Available Map Data and the captured aerial images. The maps can include maps created from portable SAT NAV devices, aerial photography, other source or simply from government available mapping data.

“Overlay Metadata” as used herein refers to the coding an image, either as an overlay or just below the image, for management and subsequent processing of the image. A data overlay can be built as a data structure on a logical space defined by the processing program preferences.

“Point of Reference Offset” as used herein refers to a distance and direction from the center of a sensing device to a base reference point (e.g. where the camera platform is) to the Target Feature for Image Alignment.

“Sensing Device Data” and sometimes also referred to as “GPS Data” refers to data refers to data comprising values such as latitude, longitude and altitude.

“Synthesized Interstitial Images” as used herein refer to a still shot of a specific point in the visualization, said still shot which may include a captured frame or a synthesized frame from two frames.

“Target Features for Image Alignment” as used herein refers to an identifiable stationary boundary/feature. In some embodiments for example, one would match image to data comprising an identifiable stationary boundary/feature can include a road edge, a definable boundary of a manmade structure, any landmark or object in a geo-spatially encoded data file, a change of a sensed wavelength due to a structure or barrier, for example, a stationary recognizable temperature boundary detected by an infrared camera. In some embodiments, the matching can also include other image file(s), such as, a satellite image that has been encoded with pixel accurate position data.

“Video” as used herein refers to the processing and transmitting of one or both captured images and synthesized generated images, in part or whole, at one or more rates to represent scenes in motion.

In some embodiments of the present invention, image data can be captured via one or more image capture devices, such as, for example, an array of cameras. Image captured devices can be arranged, for example, in a case mounted to on an aircraft for image capture during flight of the aircraft. The image capture devices may be firmly mounted in relation to each other and include multiple image capture perspectives.

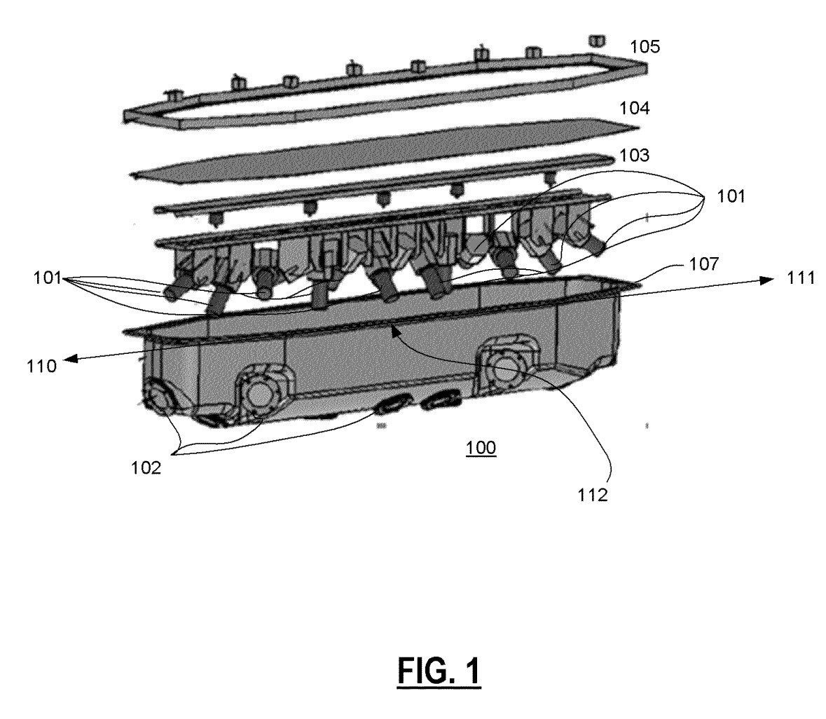

Referring now to FIG. 1, an exemplary camera apparatus assembly 100 according to some embodiments of the present invention is illustrated. As illustrated, multiple cameras 101 may be mounted to a camera mounting frame 103. The mounting frame may be fixedly attached to an aircraft such that it will respond to pitch, roll and yaw, as opposed to other aircraft camera mounts, and is aligned to a subject that includes a geographic area. The camera mounting frame 103 fixedly secures the cameras 101 such that the cameras 101 can be focused in multiple directions. In some embodiments, each camera 101 is focused in a unique direction as compared to the other cameras. In additional embodiments, redundant cameras may be directed in a same direction such that more than one camera 101 is focused in a single direction. However, it is generally preferable that multiple cameras are focused in multiple directions, whether some image field of view redundancy exists or not. Some embodiments may additionally include cameras 101 that are specifically focused in overlapping areas and thereby include overlapping scopes of image data capture. Embodiments with overlapping scopes of image data capture may be more conducive to alignment of captured image data frames.

Cameras 101 may be arranged in a generally linear formation, such as, from a first point 110 in a forward direction of an aircraft, and a second point 111 in an aft position. Other configurations of camera positioning, such as in different locations on an aircraft including wing tips, nose and/or tail, are also within the scope of the present invention. A linear arrangement of image capture devices 101, such as cameras, may provide for decreased aerodynamic resistance to an atmosphere through which the aircraft travels during flight of the aircraft on which the image capture devices are mounted.

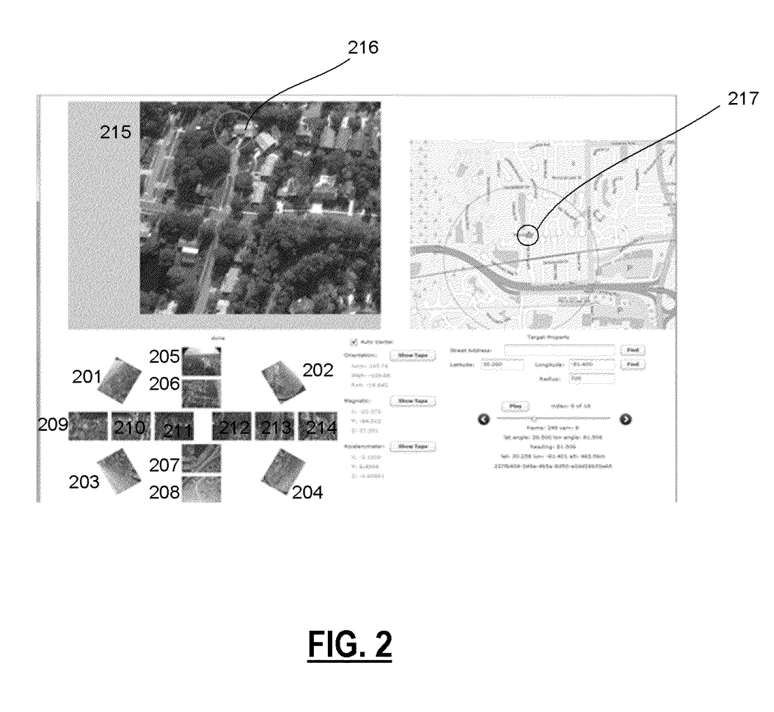

In some embodiments, a midpoint 112 is defined wherein a generally linear array of image capture devices 101 are arranged to provide multiple scopes of image capture (illustrated in FIG. 2) in a fore and aft direction.

In another aspect, some embodiments may include a gasket 104 or other vibration insulator that may be placed in position between the camera mounting frame 103 and a housing mount 105. The gasket may include a neoprene, silicone, polymer, cork or other material which will absorb vibration inherent in the operation of the aircraft. Some embodiments may include a computer, hydraulic, or spring controlled stabilizer to counteract vibration to which an image capture device is exposed to during image capture. The housing mount can include a frame for fixedly mounting the camera apparatus assembly 100 to an aircraft. The vibration insulator is not meant to compensate for pitch, roll and yaw, but only for high frequency vibration of the aircraft during operation. For example, this high frequency vibration can be caused by the engine and propeller.

A camera housing 107 may be included to provide a protective covering 107 for the multiple cameras 101. Preferred embodiments include a protective covering 107 that is more aerodynamically efficient as compared to uncovered cameras mounted on the camera mounting frame 103. The protective covering may be any rigid or semi-rigid material; however, a thermoplastic material is generally preferred, due to the relative lightweight properties and ruggedness of such materials.

One exemplary thermoplastic material includes Acrylonitrile butadiene styrene (ABS). Important mechanical properties of ABS include its inherent impact resistance and toughness. In some embodiments, the impact resistance of the ABS may be increased for the use as a protective covering 107 by increasing a proportion of polybutadiene in relation to styrene and also acrylonitrile. Another preferable quality of a protective covering 107 material is that the impact resistance should not fall off rapidly at lower temperatures.

An airplane or other aircraft may travel from sea level to high altitudes and encounter significant temperature changes during such travel. The protective covering needs to be functional for all temperature ranges encountered.

Additional materials that may be useful as a protective covering may include, for example, aluminum, stainless steel, carbon fiber or other aircraft quality material. In some embodiments including a protective cover 107 with an opaque material, clear view portals 102 may be included in the protective covers 107, wherein the view portals 102 include a material transparent to a wavelength of light utilized by the image capture devices 101 to capture image data.

In some embodiments, image capture devices, such as cameras 101 capture images based upon a wavelength of light in a spectrum viewable by the human eye (generally including wavelengths from about 390 to 750 nm, in terms of frequency, this corresponds to a band in the vicinity of 400-790 THz), other embodiments may include image capture devices, such as cameras 101 which capture images based upon an infrared wavelength (0.8-1000 μm), microwave wavelength, ultraviolet wavelength (10 nm to 400 nm) or other wavelength outside the spectrum viewable by the human eye. Other embodiments can additionally include LIDAR frequencies in addition to other wavelengths or as a standalone data in different processing techniques.

Referring now to FIG. 2, an example is illustrated of a configuration of multiple scopes of image capture 201-214 associated with an array of image capture devices (not shown in FIG. 2, but illustrated in FIG. 1 as item 101). As discussed above, multiple image capture devices may be fixedly aligned on an image capture mounting frame along a generally linear path, wherein each of the multiple image capture devices includes a scope of image capture directed to a point away from one side of a geometric plane tangential to an underside of the aerial vehicle. As illustrated, in some embodiments, fourteen cameras may be arranged on a camera mounting frame such that each camera is directed in a unique direction.

In some preferred embodiments, image capture devices are arranged such that a first array of between four (4) and eight (8) scopes of image capture 209-214 (associated with a first set of image capture devices included in a linear array of between four (4) and twenty (20) image capture devices, and preferably fourteen (14) image capture devices), are orthogonally crossed by a second array of between four (4) and eight (8) scopes of image capture 205-208 (associated with a second set of image capture devices included in a linear array of between four (4) and twenty (20) image capture devices, and preferably fourteen (14) image capture devices).

In addition, one or more scopes of image capture 201-204 may be arranged at a variety of angles. For example, an angle between 0° and 90° (the angle/direction as if it were measured for an aircraft traveling North) of the first array of scopes of image capture 209-214 and the second array of scopes of image capture 205-208. As illustrated a downward forward camera 206 and a downward rear camera 207 may also be included. Such scopes of image capture 201-204 arranged at an angle between 0° and 90° of the first array of scopes of image capture 209-214 and the second array of scopes of image capture 205-208, may, for example, be at about a 45° angle to a first array or a second array of scopes of image capture. Other exemplary scopes of image capture may include an angle of about 300° 201, 0° 205, 60° 202, 120° 204, 180° 208 and 240° 203.

According to the present invention, a subject location or point of interest 216 may be identified, and image capture devices may be positioned such that one or more of the scopes of image capture 201-214 can capture the subject 216 from a different angle perspective. Image data of the subject 216 may be identified among frames of image data captured by one or more of the image capture devices during one or more flight plan. Preferably, a flight plan will include a path which allows more than one view of image capture 201-214 which capture image data of the subject during the aircraft flight.

In some embodiments, image capture devices, such as cameras, are positioned to enable image capture of an aerial level view of a neighborhood surrounding a selected geographic location during flight of the aircraft.

Various additional embodiments of the invention may include enhancements to image data captured by an array of image capture devices arranged or combination of video fly-by data with other data sources related to the geographic location. For example, enhancements to image data captured by an array of cameras fixedly attached to an aircraft with data sources related to the geographic location may include: 1) providing accurate differential GPS data; 2) post processing of geo positioning signals to smooth curves due to motion (sometimes referred to as splines); 3) highly accurate camera position and video frame position analysis processing to provide a calculation of an accurate position of multiple video frames, and in some embodiments each video frame, in some embodiments, the camera position maybe captured within 1 to 5 microseconds of the image capture; 4) parcel data processing that analyses vector line data that is geo-coded with latitude and longitude values; 5) digital image photos processed with herein described algorithms; and 6) a database that includes video image files; for example parcel latitude and longitude data; and positioning data that is indexed to image data files. With these components, the invention enables the access to video images of any desired geographic location point of interest and its surrounding neighborhood, while relating such image data to Target Features for Image Alignment, such as, property lines, landmarks, county lines, etc.

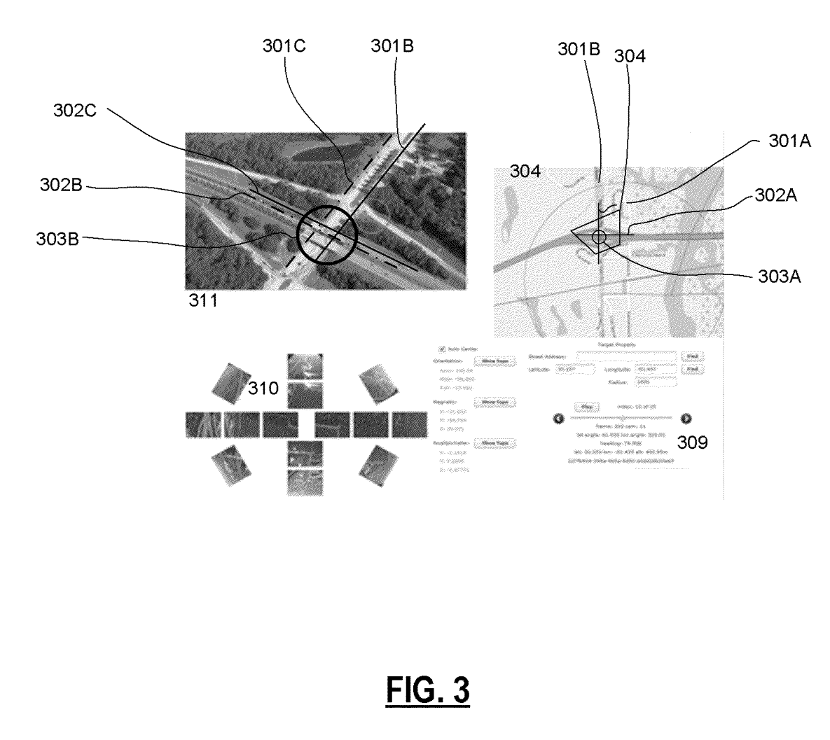

Referring now to FIG. 3, a diagram 300 is illustrated with exemplary Target Alignment Features 301A, 302A, and 303A identified in one or more frames 310 of image data captured in a scope of image data 310 by multiple image capture devices (not illustrated in FIG. 3, but shown in FIG. 1). During capture of image data frames 310 represented in a map view as projected on the ground from an aerial perspective 304, an aircraft, such as an airplane, a flotation device (such as a balloon); a glider, a helicopter, or any other airborne vehicle operating within an atmospheric layer, may be subjected to atmospheric fluctuations, such as turbulence resulting from pressure differentials. An image capture device, such as a camera (illustrated in FIG. 1), may therefore be subjected to abrupt changes of orientation due to turbulent air induced changes in a flight path of the aircraft. Changes may also result from pilot control during aerial image capture, such as, during turns.

Generally, aerial image data frames 310 are captured via an aerial vehicle on a flight path. Image data can be captured from disparate points along the flight path. An aerial flight path can include a direction of travel and an altitude 309. Positions and orientations along the flight path may be tracked via the use of sensing devices such as GPS units, digital compasses, altimeters and accelerometers.

As a practical matter, unlike street level image capture from disparate points based upon ground travel, wherein the ground is generally stable, instability of atmospheric conditions and changes based a piloted control of the aerial vehicle may result in aerial image capture from disparate points along an aerial flight path that is subjected to sudden changes in camera position, direction, and angle of image capture. Changeable aspects may include, for example, one or more of a change in: attitude; plane orientation; plane direction of travel; plane position along a path from point to point, all with a timeframe measured, for example, every 1/20 of a second by a GPS.

In addition, to artifacts 301A-303A identified in captured imaged data frame 300, some embodiments of the present invention may include enhancements, such as, image processing edge detection lines 301C and 302C drawn to more accurately represent a naturally occurring artifact 302 as a mathematical shape or line 301B, 302B and 303B. The mathematical shape or line 301B, 302B and 303B, may then be utilized to mathematically position a first image data frame 301C with a second image data frame 302C (although, multiple image data frames are not illustrated, the illustrated image data frame 300 is representative of any exemplary image data frame).

In some embodiments, the present invention is directed to aerial vehicles which traverse portions of the Earth's atmosphere with significant enough atmospheric turbulence to significantly affect a flight pattern of the aerial vehicle. For example, an image capture device, such as a camera fixedly attached to an airplane may experience change in any or all of multiple dimensions of image. Flight may include three dimensions of location including altitude and position: an X, a Y and a Z dimension, wherein the X dimension may, for example, include a latitude designation, the Y dimension may include a longitude designation and a Z dimension may include an altitude dimension. Another dimension may include direction and/or non-magnetic compass orientation of an airplane and its corresponding flight path due to crosswind.

Additional aspects of camera fixedly mounted to an aerial vehicle may experience changes due to the aerial vehicle subject to pitch, rolling, and yaw. An angle pitch, roll and yaw also become important to image capture and subsequent image frame alignment. For example, a first image may be captured by a camera, or a pod of cameras fixedly mounted to an airplane, and the airplane may roll a fraction of a degree before a second, subsequent image frame is captured. This change can cause a change of an expected position of a target object for image alignment as the plane moved in a direction predicted. According to the present invention, alignment of the first image frame and the second image frame will preferably take into account a roll variable. Similarly, a change in a position of the airplane with respect to ascending, descending and yaw, is also preferable accounted for.

Image capture may be accomplished, for example, via a digital camera or radar, such as, for example a Charged Coupled Device camera, radar, an Infrared camera, and/or any device with direction detection of distant objects. In some embodiments, individual frames of captured image data may be taken at various intervals and in this discussion, a general rate of approximately one capture per every 1/20 of a second may be assumed. A post processing algorithm may take the sensor data multiple times per second and build up a profile of the information processed such as when entering a turn, the aircraft may change direction at an accelerating rate from 1 to 2 to 3 to 5 to 7 to 9 degrees per second all within 1/20 of a second. When a camera snaps a picture (or otherwise captures image data) at 12:00:00 seconds a compass orientation associated with the aircraft and the camera may be at 180 degrees at 12:00:01 the compass orientation may be 175 degrees. With a rate of change data applied to an aircraft heading, an interpolated value may be calculated for a fraction of a second that the camera image was taken. Interpolation may be according to a mathematical value.

Common interpolation algorithms can include adaptive and non-adaptive methods. Non-adaptive algorithms can include, for example: nearest neighbor, bilinear, bicubic, spline, sinc, lanczos and others to both distort and resize a photo. Adaptive algorithms can include many proprietary algorithms, for example: Qimage, PhotoZoom Pro, Genuine Fractals and others. Many of these apply a different version of their algorithm (on a pixel-by-pixel basis) when they detect the presence of an edge to minimize unsightly interpolation artifacts in regions where they are most apparent.

According to the present invention, target feature for alignment 301A, 302A and 303A included in a captured image frame 311 may be used to align a first image frame 301C with another image frame (not shown) 302C. The Analysis Domain of the Target Feature for Alignment 303B may be identified also in a map view 303A which includes pictorial representations of the Target Feature for Alignment 301B or 302B.

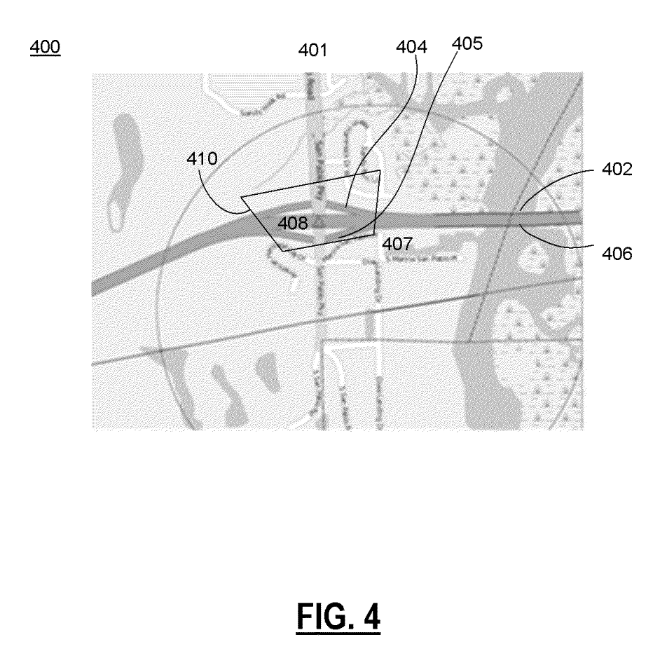

Referring now to FIG. 4, a close up of an exemplary pictorial representation 400 of a subject geographic area within an image capturing device's field of view 410 is illustrated. The subject geographic area 401 includes multiple Target Features for Image Alignment 401-402. In this exemplary representation, 403-407 include road, edges, boundaries and/or road interceptions. Additionally, at 407, a lake is depicted and accordingly the boundaries of the lake may also be used as Target Features. As indicated above, available mapping data may additionally be used to identify Target Features for Image Alignment in a captured image frame (not shown in FIG. 4), to align one image frame with another and obtain more accurate positional data.

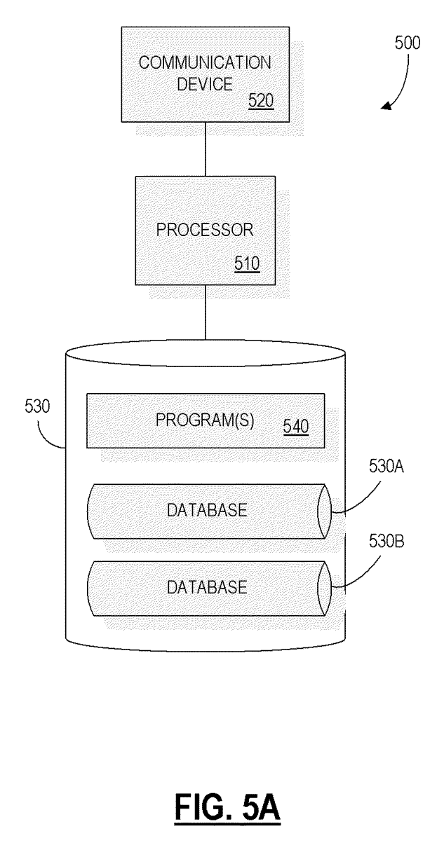

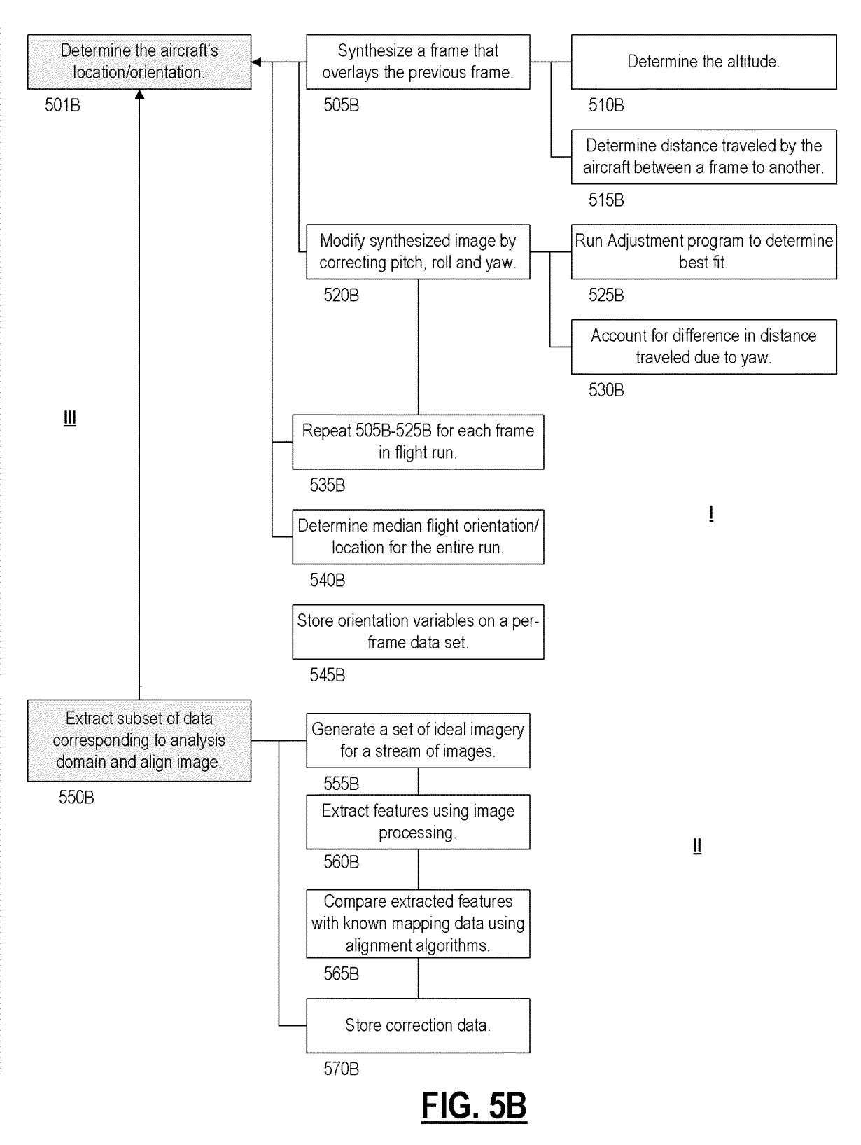

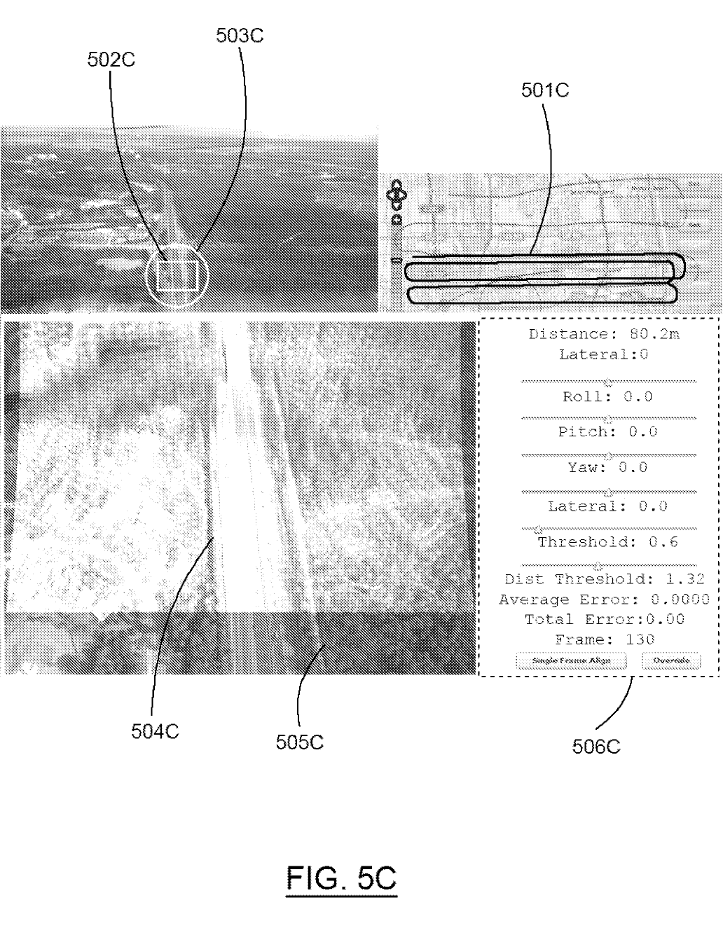

FIG. 5A additionally illustrates a controller 500 that may be utilized to implement some embodiments of the present invention. The controller 500 includes a processor unit 510, such as one or more digital data processors, coupled to a communication device 520 configured to communicate via a communication network (not shown in FIG. 5). The communication device 520 may be used to communicate, for example, with one or more logically connected or remote devices, such as a personal computer, tablet, laptop or a handheld device.

The processor 510 is also in communication with a storage device 530. The storage device 530 may comprise any appropriate information storage device.

The storage device 530 may store one or more programs 540 for controlling the processor 510. The processor 510 performs instructions of the image processing algorithms in one or more programs 540, and thereby operates in accordance with the present invention. The processor 510 may also cause the communication device 520 to transmit information, including, in some instances, control commands to operate apparatus to implement the processes described herein. The storage device 530 may additionally store related data in a database 530A and 530B, as needed.

The controller 500 may be included in one or more servers, or other computing devices, including, for example, a laptop computer, tablet, and/or a server farm with racks of computer servers.

Referring now to FIG. 5B, is a flowchart with exemplary method steps that may implemented in some embodiments of the present invention. At 501B, image processing may take place to determine the image capturing device's orientation and location as described in Figure Sections I and II. At 505B, for each subsequent frame pair, take a particular frame and calculate the distance traveled between frames. The altitude 510B and distance traveled by the aircraft between the frames 515B can be obtained from sensing device, such as GPS location. The distance calculation can include the Haversine formula to convert between lat/long in degrees to physical distance (meters). Since the altitude is in meters and the projection of the frame is in degrees (camera angles), the distance can easily be converted to pixels in flat space. For example for any two points on a sphere;

$$haversin ( \frac{d}{r} ) = haversin ( {φ}_{2} - {φ}_{1} ) + cos ( {φ}_{1} ) cos ( {φ}_{2} ) haversin ( {ψ}_{2} - {ψ}_{1} )$$

Where haversin is the haversine function of:

$$haversin ( θ ) = {sin ( θ / 2 )}^{2} = \frac{1 - cos ( θ )}{2}$$

d is the distance between the two points (along a great circle of the sphere; see spherical distance),
r is the radius of the sphere,
φ₁, φ₂: latitude of point 1 and latitude of point 2
ψ₁, ψ₂: longitude of point 1 and longitude of point 2

On the left side of the equals sign, the argument to the haversine function is in radians. In degrees, haversin(d/R) in the formula would become haversin(180° d/πR).

One can then solve for d either by simply applying the inverse haversine (if available) or by using the arcsine (inverse sine) function:

d=r haversin⁻¹(h)=2r arcsin(\sqrt{h})

where

h is haversin(d/R)

$$d = 2 r arcsin ( \sqrt{\begin{matrix}haversin ( {φ}_{2} - {φ}_{1} ) + \\ cos ( {φ}_{1} ) cos ( {φ}_{2} ) haversin ( {ψ}_{2} - {ψ}_{1} )\end{matrix}} ) = 2 r arcsin ( \sqrt{\begin{matrix}{sin}^{2} ( \frac{{φ}_{2} - {φ}_{1}}{2} ) + \\ cos ( {φ}_{1} ) cos ( {φ}_{2} ) {sin}^{2} ( \frac{{ψ}_{2} - {ψ}_{1}}{2} )\end{matrix}} )$$

At 520B, the synthesized image can be modified to correct pitch, roll, yaw and heading. In some embodiments, the process may rely heavily on the center of the point of view of the frame. As a result the lateral offset can also be taken into account in some embodiments. Yaw otherwise known as the “Crab Angle”, is the angle between the aircraft track or flight line and the fore and aft axis of a vertical camera, which is in line with the longitudinal axis of the aircraft. Where this can be a factor, to account for the lateral displacement, it may be beneficial that the angular correction has both a yaw angle and a lateral offset component. Additional factors that also affect the differences between two subsequent frames also include changes in roll, pitch, altitude, perspective due to distance traveled and heading. In some embodiments, lesser variable in the difference between frames may be accounted for and can additionally include, physical changes occurring in the frames such as moving artifacts, lighting effects such as glare spots and shades, and camera imaging variables such as noise artifacts and light/contrast normalization.

By running one or more adjustment program(s) to determine a best fit value for each of the two images 525B and accounting for the difference traveled due to yaw 530B, the image can be corrected to the perform the same for other frames in the same or different flight runs 535B. Assuming the cameras are mounted at the same angles on subsequent frames, and those angles are known, it can be possible to determine the relative changes in factors, such as the ones listed above, using different known image processing techniques. For example, GPS telemetry.

In some embodiments, the known camera angles can be used to generate a synthesized view from directly overhead. In this view, the program can further synthesize the translation of distance traveled (which is calculated), and the effects of roll, pitch and yaw variations. This synthesized view can be used to compare with the previous frame's image. The comparison can be done in the “flat space” or overhead domain, or in the more easily understood angular reference as would be seen from the camera. Additionally, the latter can be further synthesized using the reverse of the camera geometry processing used to generate the overhead view.

In some embodiments, in order to make the comparison, it may be important that the previous frames are adjusted for camera geometry and the calculated roll, pitch and yaw corrections as known, in the same manner as the current frame. However, this synthesis may not include a distance offset since the current frame is synthesized to the previous location. The comparison method used on the two frames is a simple average error per-pixel between the two frames. Those pixels that may not be synthesized from the current frame are ignored in the summation.

The initial roll, pitch and yaw values used to process the current frame image can either be the values currently applied (in the case of this being a subsequent correction processing run) or those currently saved for the previous frames. The result of the comparison is an error value, which can be saved as the best fit value.

For example, when the comparison steps are repeated, by varying the 3 angular parameters (roll, pitch and yaw) and generated updated error values, the pitch angle can be altered by subtracting 0.1 degrees and a new error value may then be calculated. If the error is less than previous, then this error can be used as a new target, and the three angles can be saved. If the error is higher than the previous, then a count can be incremented to track the number of iterations the process has gone in the wrong direction. The steps may then be repeated to obtain the angles with a lowest error. A sequence of frames can be processed in this manner, generating a sequence of frame corrections. Once the complete sequence is processed, the median correction angles are determined for each roll, pitch and yaw 540B. Values may then be stored on per frame data sets for later processing 545B. Later processing can include, for example, normalizing the sequence of frame by offsetting the angles using these median values.

At 550B, the image may be extracted and aligned using known mapping data. For example, Open Streets Map Existing Data. The alignment can be narrowed down to an analysis domain which can result from altitude and GPS measurements during image capture. At 555B, a set of ideal imagery is generated for a stream of images using the median values as explained above. Target Features for Alignment may then be extracted using image processing 560B. This can involve for example, finding the centerlines of the primary roadways and boundaries of geographically significant objects, such as large bodies of water. Target features for Alignment in images may be determined, for example, using the Canny Edge algorithm.

Using the Canny algorithm can allow for the digital discovery of a Target Feature for Alignment. A good Target Image for Alignment can include good detection (the algorithm should mark as many real edges in the image as possible), good localization (edges digitally formed should be as close as possible to the edge in the real image), and include minimal response (a given edge in the image should only be marked once, and where possible, image noise should not create false edges).

To satisfy these requirements, calculus of variations can be used. This technique can find the function which optimizes a given functional. The optimal function in Canny's Algorithm detector can be described by the sum of four exponential terms, but can be approximated by the first derivative of a Gaussian.

For example, an image after a 5×5 Gaussian mask has been passed across each pixel. The Canny Algorithm edge detector can use a filter based on the first derivative of a Gaussian, because it can be susceptible to noise present on raw unprocessed image data, so to begin with, the raw image can be convolved with a Gaussian filter. The result can be a slightly blurred version of the original which is not affected by a single noisy pixel to any significant degree. An example of a 5×5 Gaussian filter, used to create the image to the right, with σ=1.4:

$$B = \frac{1}{159} [ \begin{matrix}2 & 4 & 5 & 4 & 2 \\ 4 & 9 & 12 & 9 & 4 \\ 5 & 12 & 15 & 12 & 5 \\ 4 & 9 & 12 & 9 & 4 \\ 2 & 4 & 5 & 4 & 2\end{matrix} ] * A .$$

Finding the intensity gradient of the image can allow for a binary edge map, derived from the Sobel operator, with a threshold of 80. The edges can be colored to indicate the edge direction, for example: yellow for 90 degrees, green for 45 degrees, blue for 0 degrees and red for 135 degrees.

A Target Feature for Alignment in an image may point in a variety of directions. As a result, the Canny algorithm can use filters to detect horizontal, vertical and diagonal edges in the blurred image. The Target Feature for Alignment can return a value for the first derivative in the horizontal direction (Gx) and the vertical direction (Gy). From this the edge gradient and direction can be determined:

$$G = \sqrt{{G}_{x}^{2} + {G}_{y}^{2}}$$

$$Θ = arctan ( \frac{{G}_{y}}{{G}_{x}} ) .$$

The edge direction angle can then be rounded to one of four angles representing vertical, horizontal and the two diagonals (0, 45, 90 and 135 degrees for example).

A binary map can be generated after non-maxima suppression. Given estimates of the image gradients, a search can be carried out to determine if the gradient magnitude assumes a local maximum in the gradient direction. From this stage referred to as non-maximum suppression, a set of edge points, in the form of a binary image, can be obtained.

Edges found may then be Traces through the image and hysteresis thresholding. Once this process is complete, a binary image can be formed where each pixel is marked as either an edge pixel or a non-edge pixel. From complementary output from the edge tracing step, the binary edge map obtained in this way can also be treated as a set of edge curves, which after further processing can be represented as polygons in the image domain.

In some embodiments, differential geometric formulation of the Canny edge detector can be implemented. This process can include sub-pixel accuracy is by using the approach of differential edge detection, where the requirement of non-maximum suppression is formulated in terms of second- and third-order derivatives computed from a scale-space representation.

In some embodiments of the present invention, a secondary analysis may then be used to find long, straight elements by finding strings of non-edge space. This process can include techniques, such as the technique described by Li and Briggs in “Automatic Extraction of Roads from High Resolution Aerial and Satellite Images with Heavy Noise”. However, it may be that as a first step the processing described above looks for long, open spaces, essentially the largest ellipse that can fit, and this secondary analysis looks for the smallest circle fit. During this secondary analysis, large open spaces can be found from the simple edge detection. Further, the long, straight elements can then stitched together to create road or river polylines. Accordingly, these features may then be compared to the available mapping data and aligned. Thresholds can be set so that the per-frame alignment fits within an adjustment window, or the frame is consequently ignored. To the contrary, if the alignment is within bounds, it can be used to adjust the normalized correction angles for the entire sequence.

At 560B, geo-referencing the adjusted frames with known geographic data with extracted Target Features for Alignment can be compared. This may be done to include a more accurate location data. The correction data may then be stored 570B for subsequent processing of images in an orderly format.

Referring now to FIG. 5C, an exemplary representation of how the orientation alignment can be accomplished by varying the roll, pitch and yaw of an aircraft is depicted. At 501C, a number of flight paths that are associated with a particular location are depicted. The flights path may be recorded, along with data points for processing steps consistent with FIG. 5B. For example, images with data sets from different flight paths associated with one point location may be used to produce more angular view planes of the particular artifact or point location.

At 506C, an exemplary orientation alignment and location fix panel screen shot is depicted. In this exemplary fix panel, the system has found that the best fit corresponds to a roll of −0.1 degrees, pitch of −1.2 and yaw −0.1. As discussed previously, other factors can be implements to calculate the more the orientation and more accurate location. For example, in this screen shot lateral, threshold and dist are also included.

At 502C, a linear road identifiable artifact 502C, i.e. Target Feature for Alignment, is shown within the particular Image Capture Device's Domain 503C that may be used for alignment is depicted. The target image 505C can be behind the panel 504C. The two radicals are supposed to be centered on the cross road on the highway, but are slightly low. In this example, it can correspond with the Pitch −1.2 value. Basically, this could be due to a variety of factors. For example, the aircraft was flying slightly nose low due to a change in airspeed, and/or a slight mounting correction on the image capturing device.

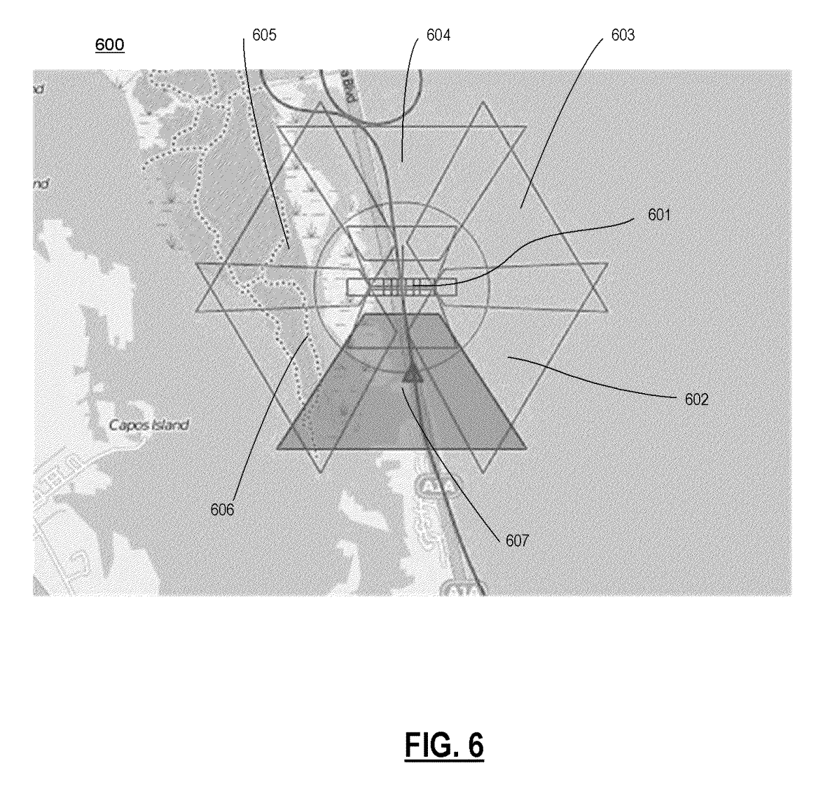

Referring now to FIG. 6, an exemplary field of view angles of an artifact from image capturing devices mounted on an aerial vehicle are depicted. Captured Arial Images from the different field of views can comprise location data for post-processing. At 601, an aerial vehicle is depicted approaching target location or point of interest while capturing images from different angles of view. At 602-607 six (6) overlapping angular planes are shown which may capture the target point, surrounding area or a point of reference from different angles as it approaches. The recorded images may be logically arranged according to the Aerial Images' Location Data so that a location of the camera, orientation and time at which the image is recorded can later be used figure out an exact location of and viewpoint direction of the capturing devices at the time of capture as previously explained. In some embodiments, an Analysis Domain may additionally be used by the system to limit the number of calculations the system can perform. For example, the calculations can include calculations that include the Aerial Images' Location Data for alignment with identified Target Features from the capture image and publicly available global road mapping data or any other shared map data files that can be suitable for processing.

At 607, the field of view of a downward approaching image capturing device is depicted. The angle of the field of view is known and can be used in calculations. In some embodiments, it may be beneficial to use the approaching image capturing device to identify Target Features for Alignment and obtain best fit values, etc. The values may then be used to obtain the same for the other field of views assuming that they image capturing devices stay fixed in relation with each other during the capturing of the images.

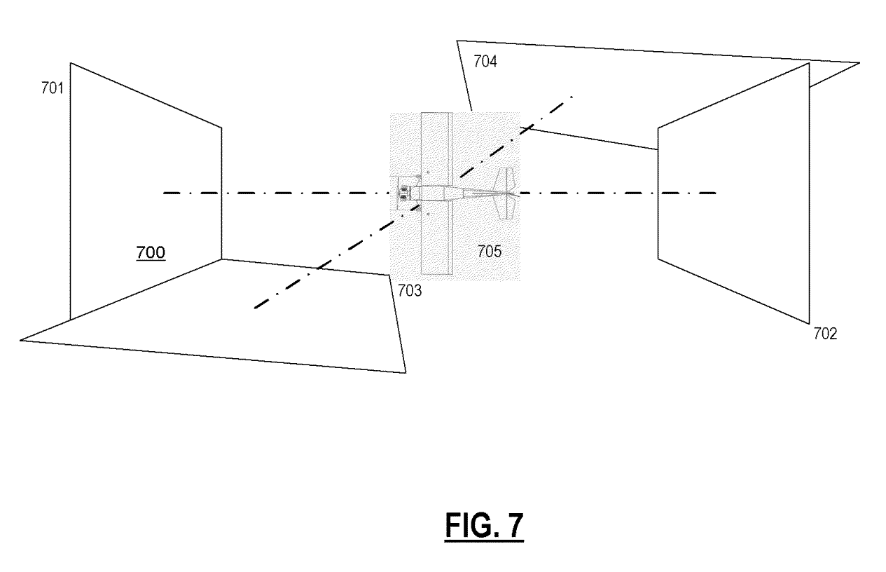

Referring now to FIG. 7, exemplary angles of capture are depicted to explain additional aspects of the present inventions. As explained in FIG. 1 of the present invention, image capturing devices can be oriented at different angles relative to the downward tangential plane of the aerial vehicle to capture different perspectives. At 701 and 702, approaching and receding perspectives respectively, of image capturing devices mounted on an aircraft 705 are depicted. At 703 and 704 only two approaching and receding angular perspectives are depicted for purposes of this discussion. However, any number of cameras and perspectives/angles of capture may be implemented and are in the scope of the present invention.

As previously explained, aircrafts may take one or more series of Aerial Images with Location Data in a system that allows Automated Registration for processing. The processing which includes a series of steps to Deturbulize a Melded Image Continuum to provide different functionality, for example a smooth video fly-by visualization, accurate Latitude and Longitude, and identification of objects on the ground. In some embodiments of the present invention, because the angles of capture for each capturing device can be measured in relation to the aircrafts plane, it is also known what the perspectives are in relation of each other and how one camera's perspective frame can be manipulated after finding the best fit for another image. For example, after matching the patterns of images from the approaching image capturing device and a best fit, the values may be used to figure out how other perspectives should be manipulated in relation to those values to obtain desired imaging.

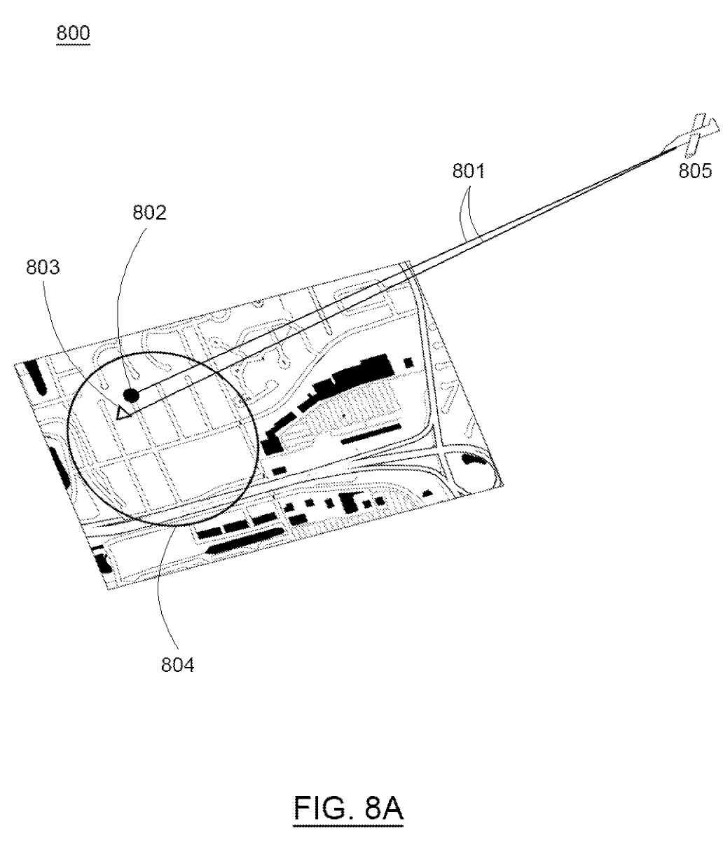

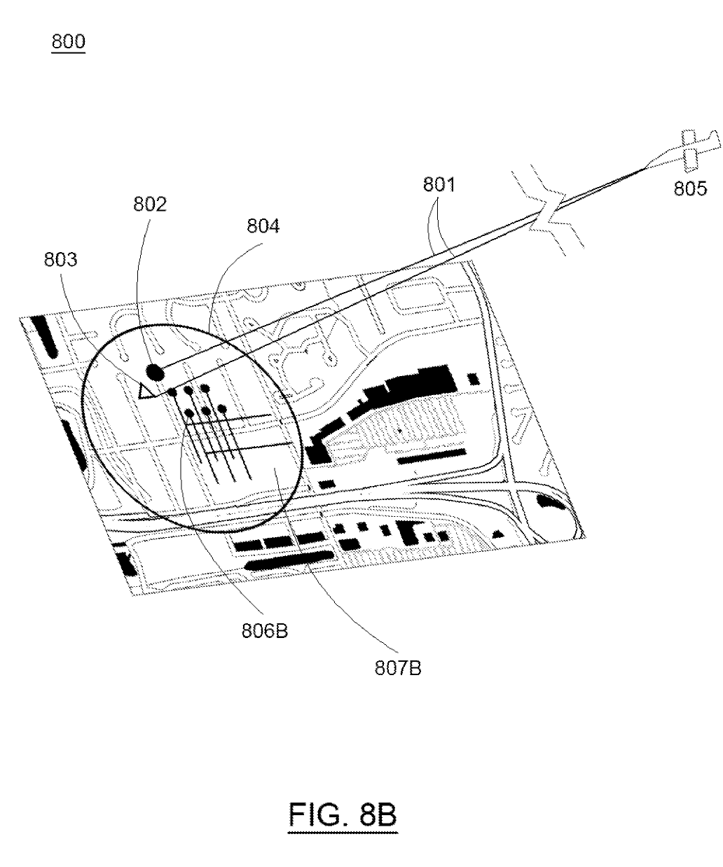

Referring now to FIG. 8A, an exemplary point of reference offset given by a global positioning system. At 805, an exemplary aerial vehicle is depicted. As illustrated in the example, two different lines 801 are depicted from the aerial vehicle to two location points in an existing map. In various embodiments, additional lines may be used. At 804, a Analysis Domain can be determined according to data from a location data source in which an identified artifact may be located, for example a location data source may be a GPS system. The system may use Aerial Images with Location Data from the image and determine that the artifact is located at 802. However, according to the present invention, a pattern recognition algorithm may be used, as described above, to match a location of an artifact within captured image data with a location of an artifact on map data 803. Accuracy of the placement of the captured image in existing map data may thereby increase for example from a +/−10 meters offset error to a +/−0.2 meter or less offset error accordingly.

Referring now to FIG. 8B, the exemplary point of reference offset of FIG. 8A with a feature matching method as it may be implemented by the system is depicted. At 806B, various features may be identified within the Aerial Images with Location Data. As explained in previous sections, the system of the present invention may determine one or more of: an angle of field of view, time of capture, distance from an artifact and an approximate location. A Target Feature for Alignment in the image capture 806B can be identified and a series of pattern matching experiments to align the captured image feature with the same feature in available map data 807B.

In some embodiments, the pattern matching process may be performed as a correction process. For example, for each frame taken, the previous frame can be analyzed to thereby synthesize an image of the current frame so that it is set back in time with the proper distance based on the delta from the GPS. The synthesized image may then be used to find the best fit to correcting for the roll, pitch and yaw. i.e. Deturbulizer.

An image in a synthesized way can be compared to an ideal image, where the previous image is not necessarily ideal. If you are flying straight level it can be sufficient. However, to account for the changes due to turbulence, the software can the shuffle automatic visual assessment to base feedback on the pixel differences between the two images. The software can then take the total average error=total distance by pixel/number of pixels used for the matching. The best error average per pixel then can be the best fit.

Consequently, even though the frames are two different frames, it looks like one matching frame corrected in the synthesis process using those correction numbers from the previous fix to synthesize the two images. Further, as further described in other parts of this invention, the system can include a player where the frames can be interpolated so that a new frame comes in as the old one is going out. Doing this can allow the system to take the entire flight run from beginning to end and step through on a portion of a second basis to present an image as if the viewer was flying through an endless non-frame based film strip, all images captured from one camera but across multiple frames of capture.

Referring now to FIG. 9, an exemplary representation is depicted in frames A, B, and C of how the mathematical algorithms, e.g. Canny algorithm, may be used to align existing property data with aerial image data to get data and determine a location of the aircraft.

At 901A, 901B and 901C, property lines are depicted from existing map data, such as for example, county property data or other governmental data. Coordinates for this property lines in the existing map data are already determined. At 901A, a road interception has been identified by the system in a captured image's encoded Geo-spatial Oriented Image Data which can be processed to provide an approximate location in the existing map data. Thereafter, pre-programmed mathematical algorithms may be applied. Other exemplary mathematical algorithms can include those utilized to manipulate imagery in the gaming industry. The algorithms may be applied to shift a position of a captured image, within a determined location domain as depicted in 902A-902C to pattern match artifacts in the image captured and record alignment data. Alignment data can serve to determine a much more accurate location of the image capturing device at the time of the image capture, in relation to the image capturing device's calculated orientation.

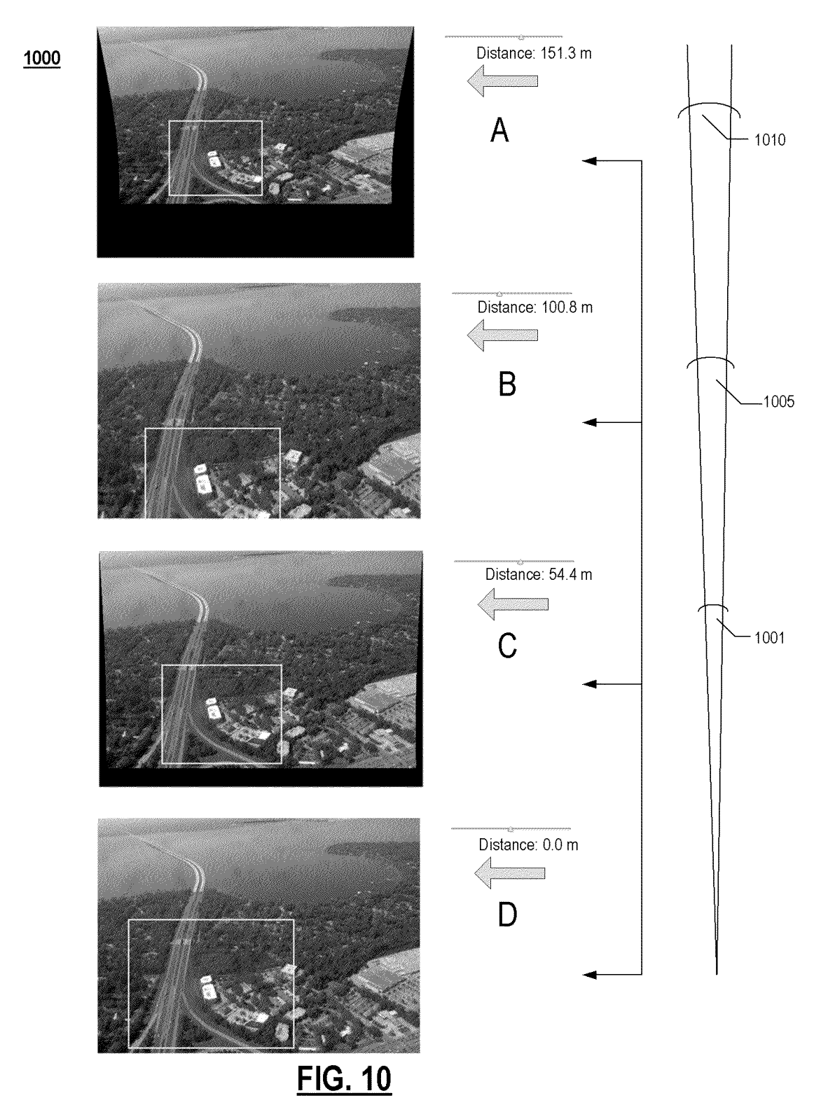

Referring now to FIG. 10, four exemplary representations depicting how a captured frame can be synthesized to enable the simulation of a desired number of frames to simulate a Smooth Video Flyby are shown 1000. Starting at Frame D, an Image Capturing Device captures a first image frame followed by Frame C at approximately 50 meters from D, Frame B at approximately 100 meters from frame D and Frame A at approximately 150 meters from Frame D.

In this exemplary embodiment, the rate of capture is approximately every 50 meters at the speed which the aircraft is traveling. The rate of capture can be pre-programmed into a processor in communication with the image capturing devices. A higher rate or lower rate may be desired depending on the speed of the aircraft. In some embodiments, using known techniques in the art or techniques previously described herein, once an exact location and orientation for the image capturing device is known for each frame, the system can use a programmed algorithm comprising an algebra equation to solve for either the rate of capture or the traveling speed of the aircraft in relation to a target. However, in some embodiments it is possible that frames from different aircrafts and/or different flight paths can be used for processing. In such event, Target Artifacts for Alignment can be used along with location data to align the images and process in relation to the spatial point of capture.

At 1001, an angle is depicted that corresponds to the difference angular perspective of Frame C, to a target from previous Frame D. Accordingly, the processing for alignment and for the generation of visualization that simulates Smooth Video Flyby in a preferred embodiment can include the morphing of pixels to Flatten the current frame to enable processing. The morphing of the pixels is done in relation to the distance and angle using digital image processing algorithms, such as the Haversine Algorithm as previously described. Consequently, at greater distances, Frames B and A, the angles 1005 and 1010 will be much greater as depicted.

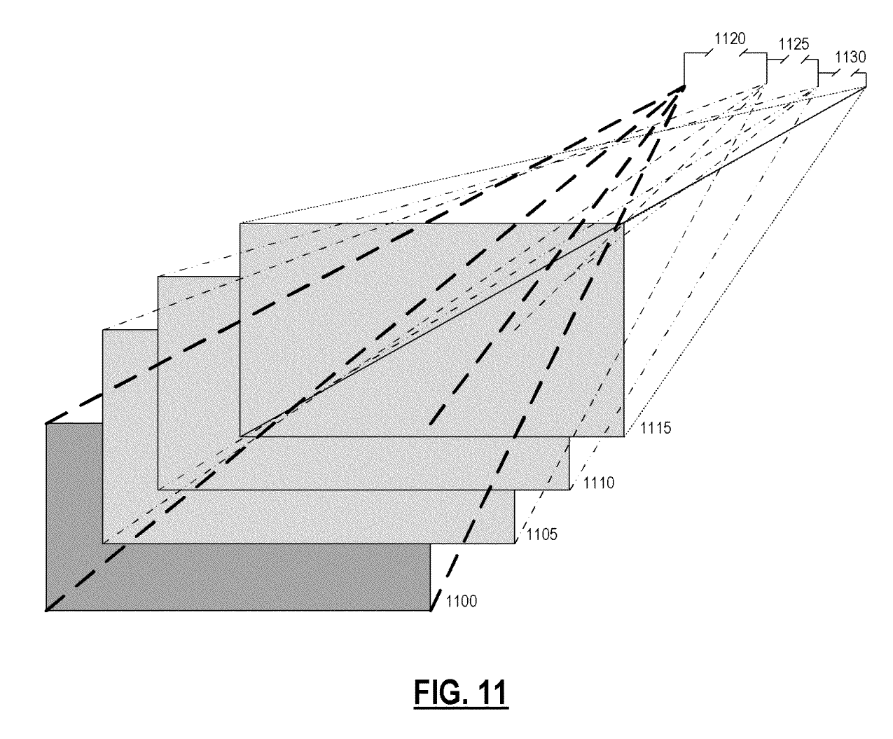

Referring now to FIG. 11, four (4) frames are depicted sequentially to give an example of how two captured images, for example the in Frame D and C of FIG. 10, can be synthesized to generate a number of images with points of captured in between the two, to simulate a Smooth Video Flyby visualization. In this exemplary representation, at 1105 a first captured image frame is used in conjunction with 1100 to generate frames 1105 and 1110 to simulate a higher rate of capture. For example, the 50 meters between frames may be reduced to 15 meters at 1130 and 30 meters at 1125 as it may be sufficient for the simulation in some embodiments. As it will be apparent to a person of the ordinary skill in the art, the number of generated frames and rate is only limited by the resolution desired for the application and processing speeds for the simulation. For example, if the distance between two captured frames is over a certain distance, the resolution of the simulation may be compromised due to the pixel stretching angle requirements being proportional to the distance.

In some embodiments, frame 1100 may be a higher resolution than frames 1105, 1110 and 1115. This may enable faster processing speeds and a simulated smooth video flyby perspective that ends in frame 1100 to render what appears to be a visualization that used higher definition images throughout.

According to the present invention, image data derived from image data sets corresponding to the three-dimensional models can be sprayed over the three-dimensional wireframe model (i.e. the process of assigning a 3 dimensional representation to a 2 dimensional image). In addition, positional and orientation data can be related to each wireframe model and used to position the wireframe model relative to other image data and wireframe models. In some embodiments, wireframe models can be arranged in a continuum of 2 dimensional and derived 3 dimensional image data according to the positional data. This may be done, for example, by using graphics processing language. The process may include taking the image from the capturing device and un-projecting it into flat space (i.e. as it would look from an orthogonal view), to apply it as a texture map to a 3 dimensional geometry. Accordingly, this geometry may be a wireframe or vector model.

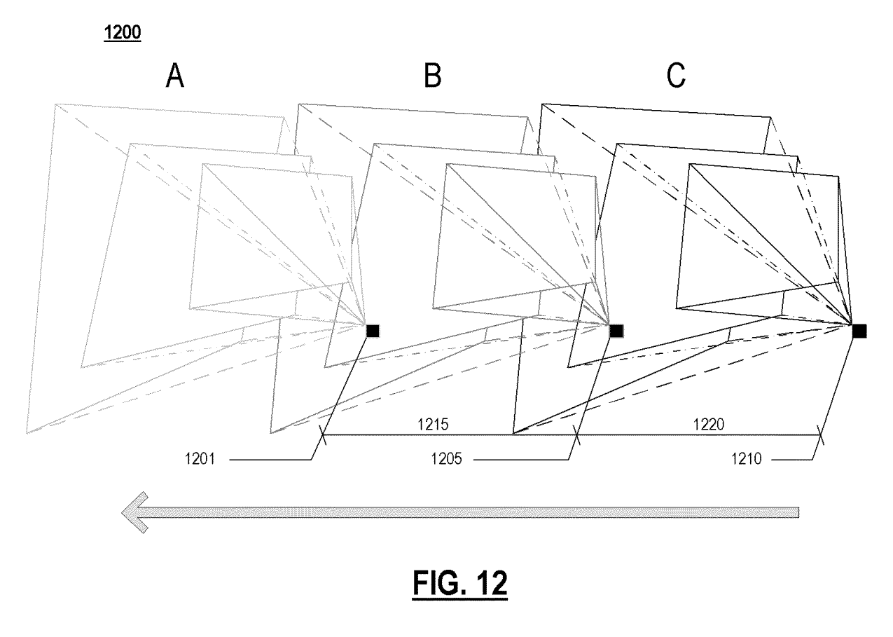

Referring now to FIG. 12, a series of oblique frames is depicted to help explain how portions overlapping between frames can be used to generate a Melded Continuum of images. In some preferred embodiments, image data can be sprayed over the three-dimensional wireframe formats which include a composite image formed by aligning two or more of the image data sets. This may be done using techniques described by the present inventor in U.S. Pat. No. 7,929,800 entitled “Methods and apparatus for generating a continuum of image data”. More importantly, the inventor in the present invention enables melding of the images from one or more sequences of images, where the projections and orientations can change due to atmospheric turbulence.

Once a sufficiently accurate position and orientation is obtained for two or more captured images, the appropriate projections can be applied to enable melding of the aligned images.

Using this methodology, unlike stitching processes previously known, the composite of image data sets can be aligned from overlapping portions of data from more than one data set.

Alignment can be accomplished in image data processing to form a composite image. The composite image is essentially two dimensional image data arranged as a second continuum or ribbon. The second continuum can include ongoing image data captured from the points defining the first continuum 1201, 1205, and 1210.

In some particular embodiments, the series of points of image capture in the first continuum includes positions of an aircraft with one or more mounted image capture device, such as a camera, as the vehicle traverses a path proximate to a target. The camera is positioned to capture image data of the target and geographic area surrounding the target. Image data A, B and C is periodically captured as the vehicle traverses the path. The motion of the aircraft, combined with the periodic capture of image data, thereby results in image data being captured from disparate points along the first continuum.

A preferred embodiment includes capture of image data with a motion vector of the camera in space maintained generally oblique perspective to a subject for which image data will be captured. During image data processing, some or all of the images are aligned to form a composite image in the form of a continuous pictorial representation of the target area. One commercial embodiment of a continuous pictorial representation includes RibbonView™ by Visre, Inc. RibbonView™ correlates a ribbon of geographic image data with geospatial designations to facilitate identification of a particular target area.

In some embodiments, select overlapping portions of two or more sets of captured image data are aligned to generate the composite image. Unlike a traditional photograph taken, the length of a horizontal plane defining a composite image may only be limited by the length of a continuum along which points are defined and from which image data is captured.

The use of only slices of data from any particular captured image can provide for a higher quality image. The quality can be increased, for example, when a temporary obstruction, such as a passing car, person or animal, captured in one image data set, is only represented in a thin slice of a continuous ribbon data. In addition, alignment of multiple thin slices of image data can be facilitated from the perspective of which aberrations typical human sensory is capable of distinguishing.

The width of a particular slice may vary, for example, upon one or more of the velocity of a vehicle from which image data sets are captured, the sample rate of a camera used to capture an image data set 1215 and 1220, the resolution of a picture comprising an image data set and the path of a camera. For example, a high resolution image generated by a 2.1 mega pixel camera may have a 1600 by 1200 resolution and allow for a thinner slice that includes a width of between about 50 to 700 pixels of an image data set.

It will be apparent to those skilled in the art that the length of a composite image generated according to the present invention is limited only by the ability to capture image data from additional points on a continuum and store the captured image data for post processing. Image data processing allows for the alignment of portions of the image data compiled into a composite two-dimensional view that can continue so long as additional image data is made available to be added to it.

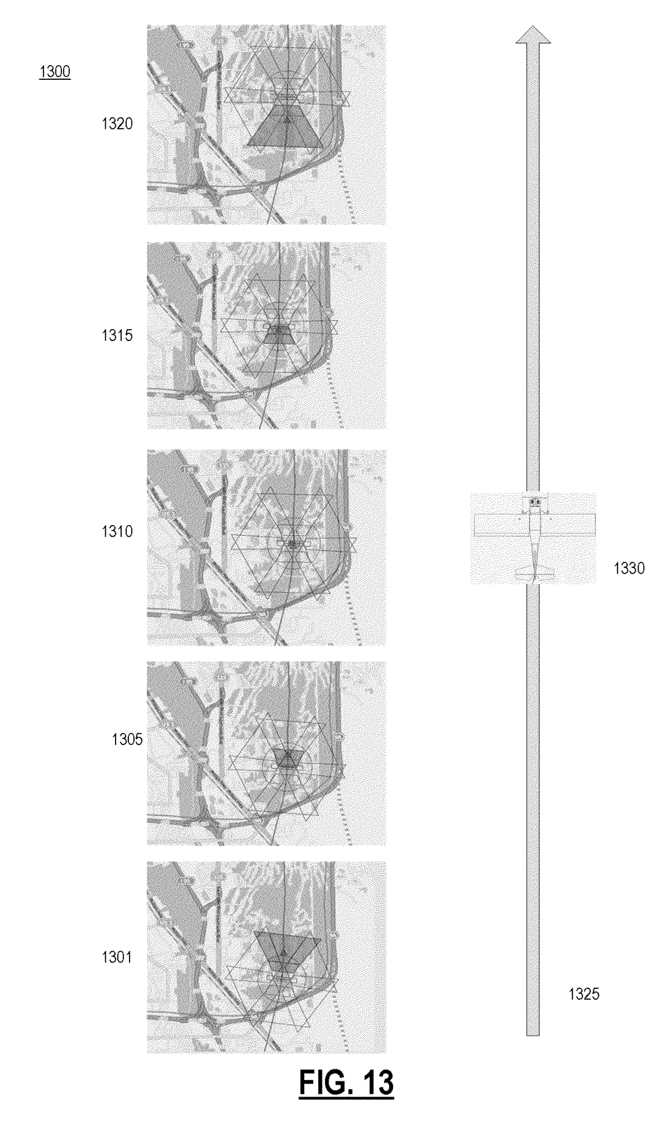

Referring now to FIG. 13 an exemplary change in image capturing devices when the aircraft flies over a target area to obtain views from different angular perspectives is depicted. At 1330 an aircraft is depicted traveling towards the North 1325. As explained in FIG. 8, the Aircraft 1330 can include multiple image capturing devices with different perspectives. The perspectives of the image capturing devices are depicted in relation to a target area in maps 1301-1320. As shown in 1301, the aircraft is approaching the target area and the shaded trapezoid represents a desired angular perspective of a image capturing device. As the Aircraft continues to travel north, at 1305 a second approaching image capturing device with a much narrower field of view can capture the target area. As the Aircraft directly flies over the target 1310, overlapping field of views from two or more image capturing devices or one image capturing device orthogonal to the target can be used. Continuing the flight path, the Aircraft can pass the target area and opposing capturing devices can capture receding frames at 1315 and 1320. Image frames of this exemplary path can then produce approaching and departing smooth video flyby simulations accordingly.

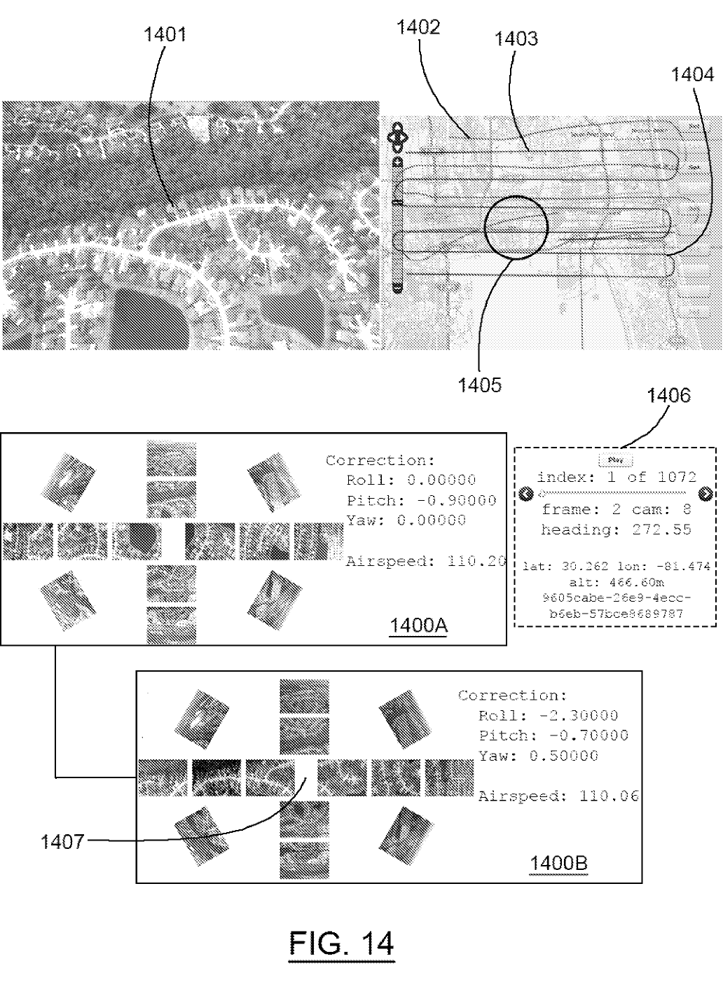

Referring now to FIG. 14, an exemplary interface for the user to simulate a Low Altitude Flyby is depicted. At 1402-1404 different flight paths of an aircraft are depicted. The flight paths can contain frames that include the target area 1405, for example a House 1401, and therefore may be used in the smooth flyby simulation. At 1406 different frames are selected and processed for the simulation. The frames can include angles perspectives, for example like the ones depicted at 1400A, 1400B. Accordingly, the frames can be processed to simulate a Smooth Video Flyby that include any of the angular perspectives depicted. The perspectives may approach or depart a target as may be desired.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

What is claimed is:

1. An apparatus for delivering smooth motion video simulations and Synthesized Interstitial Images of a target based upon geographic positional data, the apparatus comprising:
a computer server comprising a processor and a storage device; and executable software stored on the storage device and executable on demand, the software operative with the processor to cause the server to:
receive digital data comprising one or more images of a specific point of interest, wherein the one or more images comprise Aerial Images with Location Data and are captured from disparate points traversed by one or more moving Aircraft(s), by two or more image capturing devices firmly mounted to the moving Aircraft;
receive Available Mapping Data comprising the target point of interest;
determine an approximate location and viewpoint orientation of the two or more image capturing devices at any point in time from the alignment of the one or more Aerial Images with Location Data and the Available Mapping Data;
synthesize a captured Aerial Images with Location Data frame using a previous Aerial Images with Location Data frame to generate a series of images based on a distance traveled; and
use synthesized frames to simulate motion views around a specific point of interest.

2. The apparatus of claim 1, wherein the software is additionally operative to extract and align the one or more Aerial Images with Location Data with the Available Mapping Data to calculate the one or more image capturing device(s) viewpoint's location and orientation.

3. The apparatus of claim 1, further comprising an image storage system that maintains one or more database(s) of imagery taken from the two or more moving image capturing devices firmly mounted to one or more moving Aircraft(s).

4. The apparatus of claim 1, wherein the software is additionally operative to overlay metadata on a composite image descriptive of identified object representations of the composite image.

5. The apparatus of claim 1, wherein the simulated motion views can derive from different images captured at different frame rates of capture.

6. The apparatus of claim 1, wherein the software is additionally operative to provide Synthesized Interstitial Images at any one specific point in time during the aircrafts' traveled path.

7. The apparatus of claim 1, wherein the simulated motion views are capable of generating a Melded Image Continuum from different angle perspectives.

8. The apparatus of claim 7, wherein the Melded Image Continuum data from the different angle perspectives can be used to generate 3 dimensional imagery.

9. The apparatus of claim 1, wherein the image capturing devices are cameras capable of capturing image data sets with wavelengths of light visible to a human.

10. The apparatus of claim 1, wherein the image capturing devices are cameras capable of capturing image data sets with wavelengths other than light visible to a human.

11. A method for generating smooth motion video and stop motion frames of a target area based upon geographic positional data, the method comprising:
receiving digital data comprising one or more images of a specific point of interest, wherein the one or more images comprise Aerial Images with Location Data and are captured from disparate points traversed by one or more moving Aircraft(s), by two or more image capturing devices firmly mounted to the moving Aircraft;
receiving Available Mapping Data comprising the target point of interest;
calculating an approximate location and viewpoint orientation of the two or more image capturing devices at any point in time from the alignment of the one or more Aerial Images with Location Data and the Available Mapping Data;
synthesizing a captured Aerial Images with Location Data frame using a previous Aerial Images with Location Data frame to generate a series of images based on a distance traveled; and
utilizing synthesized frames to simulate motion views around a specific point of interest.

12. The method of claim 1, further comprising determining the location and viewpoint orientation of the one or more image capturing devices at any point in time from the Aerial Images with Location Data by extracting and aligning the one or more Aerial Images with Location Data with said received Available Mapping Data.

13. The method of claim 1, further comprising the step of overlaying metadata on a composite image descriptive of identified object representations of the composite image.

14. The method of claim 1, wherein the simulated motion views can be derived from different frame rates of capture.

15. The method of claim 14, wherein the frame rate of the simulated motion views is proportional to the resolution of the synthesized images.

16. The method of claim 1, additionally comprising the step of providing Synthesized Interstitial Images at any one specific point in time during the aircrafts' traveled path.

17. The method of claim 1, additionally comprising the step of generating a Melded Image Continuum from different angle perspectives from the simulated motion views.

18. The method of claim 17, additionally comprising the step of generating 3 dimensional imagery from the different angle perspectives Melded Image Continuum data.

19. The method of claim 1, wherein the image capturing devices are cameras capable of capturing image data sets with wavelengths of light visible to a human.

20. The method of claim 1, wherein the image capturing devices are cameras capable of capturing image data sets with wavelengths other than light visible to a human.
